(19) United States
(12) Patent Application Publication
(10) Pub. No.: US 2024/0070954 A1
(43) Pub. Date: Feb. 29, 2024

(54) DIGITAL MAP ANIMATION USING REAL-WORLD SIGNALS

(71) Applicant: GOOGLE LLC, Mountain View, CA (US)

(72) Inventors: Luke Barrington, (US); Sujoy Banerjee, (US); Brian Brewington, Mountainview, CA (US)

(21) Appl. No.: 17/642,172

(22) PCT Filed: Apr. 14, 2021
(86) PCT No.: PCT/US21/27257

§ 371 Date: Mar. 10, 2022

(51) Int. Cl. G06T 13/60; G06T 13/40

(52) U.S. Cl. CPC G06T 13/60; G06T 13/40

(57) ABSTRACT

Methods and systems are described herein for presenting an animation of a geographic area based on current conditions within the geographic area. A client device presents a map display of the geographic area via a user interface. In response to determining to present an animation of the geographic area, the client device animates the map display of the geographic area using virtual objects overlaid on the map display which represent the current conditions at the geographic area.

### FIELD OF THE DISCLOSURE

The present disclosure relates to digital map animation and, more particularly, to presenting an animation of a geographic area that represents the real-world conditions in the area.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Today, maps of geographic regions may be displayed by software applications running on a wide variety of devices, including mobile phones, car navigation systems, hand-held global positioning system (GPS) units, and computers. Depending on the application and/or user preferences, maps may display topographical data, satellite data, street data, urban transit information, traffic data, etc. However, the maps do not depict current conditions at the geographic regions.

### SUMMARY

To provide users with maps which more accurately represent the current appearance and/or feel of a geographic area, a map display animation system may obtain condition data indicative of the current conditions at a geographic area. The condition data may include visual data as well as audio data. More specifically, the condition data may include traffic data indicative of current traffic conditions at the geographic area, crowd condition data indicative of crowd conditions at the geographic area, weather data indicative of current weather conditions at the geographic area, lighting data indicative of ambient light at the geographic area, seasonal data indicative of the state of trees and/or other foliage in the geographic area, ambient sound data indicative of ambient sounds within the geographic area, such as wind, rain, traffic sounds, constructions sounds, crowd noise, animal sounds, etc. Additionally or alternatively, the condition data may include conditions of a geographic area for the predicted time of arrival of a user to the geographic area, according to a route navigation. In another example, the condition data may include the conditions of a geographic area for a desired time, as selected by the user (i.e., the user may wish to view a map display animation depicting current conditions of the geographic area for the following morning). In another example, the condition data may include the conditions of a geographic area for a desired condition or conditions as selected by the user (i.e., the user may wish to view a map display animation depicting current conditions of the geographic area when the weather conditions are snowy).

The map display animation system may then generate an animation of the geographic area using the condition data. The animation may be a video clip (e.g., a 10 second video clip, a 30 second video clip, or a video clip of any suitable length) which may or may not include audio. To preserve privacy of people, vehicles, and/or other entities in the geographic area, the map display system may generate virtual objects which represent the current conditions without presenting live photographs or video of the geographic area. For example, the map display animation system may generate a set of virtual vehicles to include in the animation, where the number of vehicles and/or the speed in which the vehicles are traveling is adjusted based on current traffic conditions at the geographic area. In another example, the map display animation system may generate a set of virtual people to include in the animation, where the number of people and/or the geographic areas of the people are adjusted based on current crowd sizes at the geographic area. The virtual objects may be photorealistic representations which look like the real-world objects. Additionally or alternatively, the virtual objects may include non-photorealistic representations of the objects which include abstraction and artistic stylization that are visually comparable to renderings produced by a human artist. For example, the non-photorealistic representations may be inspired by artistic representations such as paintings, drawings, and animated cartoons.

The map display animation system may obtain satellite imagery, street-level imagery, or a map representation of the geographic area. In some implementations, the satellite imagery, street-level imagery, or map representation may include map features, such as roads, buildings, parks, stadiums, airports, bodies of water, mountain ranges, etc., without including people, vehicles, or other entities. The satellite imagery, street-level imagery, or map representation may also be presented from the same time of day (e.g., the middle of the day) under the same weather and/or lighting conditions (e.g., sunny conditions) and during the same time of year (e.g., the summer). The map display animation system may then apply the virtual objects to the satellite imagery, street-level imagery, or map representation to generate the animation of the geographic area which depicts current conditions. For example, the map display animation system may present the set of virtual vehicles on roads in the satellite imagery, where the set of virtual vehicles move at selected speeds in the animation. In another example, the map display animation system may adjust the lighting of the satellite imagery to indicate that it is nighttime and may add clouds and rain to the satellite imagery based on rainy conditions.

The map display animation system may then provide the animation for display on a user's client device. In some implementations, the user may provide gesture-based input (e.g., a long press) while viewing a map display of a geographic area to request an animation of the current conditions at the geographic area. The map display animation system may provide the animation in response to the gesture-based input. In other implementations, the map display animation system may automatically determine to provide the animation in response to a triggering condition. The triggering condition may be that a particular event is occurring within the geographic area, such as a sporting event or concert. The triggering condition may also be a news update in the geographic area such as a vehicle crash which is causing a traffic jam in the geographic area, or may be any other suitable triggering condition. In any event, the animation may then be automatically presented on the user's client device or the user may receive a prompt indicating that the user may want to view an animation of the current conditions at the geographic area and including a user control, which when selected, causes the client device to present the animation.

One example embodiment of the techniques of this disclosure is a method for presenting an animation of a geographic area based on current conditions within the geographic area. The method includes presenting, via a user interface, a map display of a geographic area, and determining to present an animation of the geographic area. Additionally, the method includes animating, via the user interface, the map display of the geographic area using virtual objects overlaid on the map display which represent current conditions at the geographic area.

Another example embodiment is a client device for presenting an animation of a geographic area. The client device includes a user interface, one or more processors, and a non-transitory computer-readable memory coupled to the user interface, and the one or more processors and storing instructions thereon. The instructions, when executed by the one or more processors, cause the client device to present, via the user interface, a map display of a geographic area, and determine to present an animation of the geographic area. The instructions further cause the client device to animate, via the user interface, the map display of the geographic area using virtual objects overlaid on the map display which represent current conditions at the geographic area.

Yet another example embodiment is a method for generating an animation of a geographic area based on current conditions within the geographic area. The method includes obtaining condition data indicative of current conditions of a geographic area, and obtaining map data indicative of map features within the geographic area. The method further includes generating one or more virtual objects which represent the current conditions of the geographic area based on the condition data, and generating an animation of the geographic area based on the map data and the one or more virtual objects. Moreover, the method includes providing the animation to a client device for display.

### BRIEF DESCRIPTION OF THE DRAWINGS

FIG. 1 is a block diagram of an example communication system in which client and server devices can operate to implement the map display animation system;

FIG. 2 is a block diagram of an example real-world condition data table included in a real-world condition database, which can be implemented in the system of FIG. 1;

FIG. 3 illustrates an example image or video clip of a geographic area which can be analyzed by the system of FIG. 1 for example, using semantic segmentation to identify current conditions at the geographic area;

FIGS. 4A-4C illustrate example animations of satellite views of geographic areas representing the current conditions at the geographic areas;

FIG. 5 illustrates an example street level view of a geographic area representing the current conditions at the geographic area;

FIG. 6 illustrates an example hybrid satellite/street level view of the geographic area representing the current conditions at the geographic area using photorealistic imagery;

FIG. 7 illustrates an example hybrid satellite/street level view of the geographic area representing the current conditions at the geographic area using non-photorealistic imagery;

FIG. 8 illustrates an example two-dimensional map display of the geographic area representing the current conditions at the geographic area using non-photorealistic imagery;

FIG. 9 is a flow diagram of an example method for presenting an animation of a geographic area based on current conditions within the geographic area, which can be implemented in a client device; and

FIG. 10 is a flow diagram of an example method for generating an animation of a geographic area based on current conditions within the geographic area, which can be implemented in a server device.

### DETAILED DESCRIPTION

### Overview

Generally speaking, the systems and methods of the present disclosure can be implemented in one or several client devices, one or several network servers, or a system that includes a combination of these devices. However, for clarity, the examples below focus primarily on an embodiment in which a client device presents a map display of a geographic area, such as a two-dimensional map representation of the geographic area. In response to receiving a request for an animation of the geographic area from a user (e.g., via user input such as a long press gesture), the client device may transmit the request to a server device. In some implementations, the server device then obtains background imagery such as satellite imagery, street level imagery, hybrid satellite/street level imagery, or a two-dimensional map representation for the geographic area. In other implementations, the server device generates the imagery in a photorealistic or non-photorealistic manner based on geographic data for roads, buildings, parks, stadiums, airports, bodies of water, mountain ranges, and/or other map features in the geographic area.

Additionally, the server device obtains condition data for the geographic area indicative of real-world conditions at the geographic area. The condition data may include traffic data indicative of current traffic conditions at the geographic area, crowd condition data indicative of crowd conditions at the geographic area, weather data indicative of current weather conditions at the geographic area, lighting data indicative of ambient light at the geographic area, seasonal data indicative of the state of trees and/or other foliage in the geographic area, ambient sound data indicative of ambient sounds within the geographic area, such as wind, rain, traffic sounds, constructions sounds, crowd noise, animal sounds, etc.

The server device may then generate virtual objects which represent the current conditions without presenting live photographs or video of the geographic area. For example, the virtual objects may include virtual vehicles, virtual people, virtual lighting, virtual clouds, virtual rain, virtual ice, virtual snow, virtual buildings, virtual windows, virtual animals, virtual construction sounds, virtual crowd noise, virtual animal sounds, etc. Then the server device may combine the virtual objects with the satellite imagery, street level imagery, hybrid satellite/street level imagery, or two-dimensional map data to generate an animation of the geographic area. The animation may be a video clip where the virtual objects change position or other attributes during the video clip. For example, vehicles may travel on roads at speeds that reflect current traffic conditions, crowds of people may move at speeds that reflect current crowd conditions, lighting conditions may change, clouds may form and/or dissipate, rain or snow may fall, ice may form, etc. The animation may also include audio representative of the current sounds within the geographic area.

The server device provides the animation to the client device for the user to view and/or listen to the animation. In this manner, the user is made aware of the current appearance and/or feel of the geographic area without compromising the privacy of people, vehicles, and/or other entities in the area.

In other embodiments, the server device may provide the condition data, the geographic data, the background imagery, and/or the virtual objects to the client device. The client device may then generate the animation based on the condition data, geographic data, background imagery and/or virtual objects.

### Example Hardware and Software Components

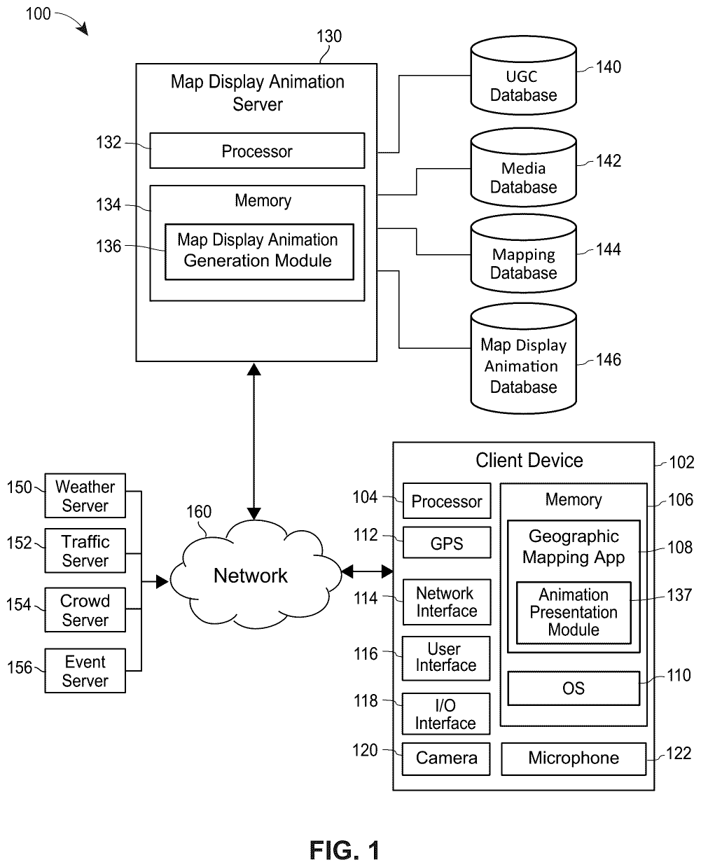

Referring first to FIG. 1, an example map display animation system 100 includes a client computing device 102 (also referred to herein as a “client device”) coupled to a map display animation server 130 (also referred to herein as “server 130”) via a network 160. The network 160 in general can include one or more wired and/or wireless communication links and may include, for example, a wide area network (WAN) such as the Internet, a local area network (LAN), a cellular telephone network, or another suitable type of network.

The client device 102 may be a portable device such as a smart phone or a tablet computer, for example. The client device 102 may also be a laptop computer, a desktop computer, a personal digital assistant (PDA), a global positioning system (GPS) unit, a wearable device such as smart glasses, or another suitable computing device. The client device 102 may include a memory 106, one or more processors (CPUs) 104, a global positioning system (GPS) module 112 or another suitable positioning module, a network interface 114, a user interface 116, an input/output (I/O) interface 118, a camera 120, and a microphone 122. The client device 102 may also include components not shown in FIG. 1, such as a graphics processing unit (GPU).

The network interface 114 may include one or more communication interfaces such as hardware, software, and/or firmware for enabling communications via a cellular network, a WiFi network, or any other suitable network such as the network 160. The user interface 116 may be configured to provide information, such as map display animations, to the user. The I/O interface 118 may include various I/O components (e.g., ports, capacitive or resistive touch sensitive input panels, keys, buttons, lights, LEDs). For example, the I/O interface 118 may be a touch screen.

The memory 106 may be a non-transitory memory and may include one or several suitable memory modules, such as random access memory (RAM), read-only memory (ROM), flash memory, other types of persistent memory, etc. The memory 106 may store machine-readable instructions executable on the one or more processors 104 and/or special processing units of the client device 102. The memory 106 also stores an operating system (OS) 110, which can be any suitable mobile or general-purpose OS. The memory can also store one or more applications that communicate data via the network 160, including a geographic mapping application 108. The geographic mapping application 108 may include an animation presentation module 137 that presents animations of geographic areas using virtual objects. The animation presentation module 137 may present the animations via the user interface 116 and/or a speaker. In addition, the memory can store geographic image files, geographic video files, geographic audio files, or other geographic media files captured by the camera 120 and/or the microphone 122. Communicating data can include transmitting data, receiving data, or both. The OS 110 may include application programming interface (API) functions that allow applications to access information from the GPS module 112 or other components of the client device 102. For example, the geographic mapping application 108 can include instructions that invoke an OS 110 API for retrieving a current geographic area of the client device 102.

The camera 120 may include one or more photographic interfaces such as hardware, software, and/or firmware for enabling the photographic capture of geographic images in the geographic image file. The camera 120 may also include one or more videographic interfaces such as hardware, software, and/or firmware for enabling the videographic capture of geographic videos which may or may not include geographic audio recorded by the microphone 122 in the geographic video file. The microphone may include one or more acoustic interfaces such as hardware, software, and/or firmware for enabling the acoustic capture of geographic audio in the geographic audio file. The geographic image files, geographic video files, and geographic audio files captured by the camera 120 and/or the microphone 122 may be geotagged (have geographical identification added to the metadata of the geographic files) based on geographic area information collected by the GPS module 112.

Depending on the implementation, the geographic mapping application 108 can display mapping content including navigation information, mapping information, geographic images, or map display animations, where the mapping content is of geographic areas, provide user-controls for exploring geographic areas by navigating through the mapping content, display interactive digital maps indicating geographic areas where mapping content is available, request and receive generated mapping content, provide user-controls for requesting mapping content reflecting user-specified conditions, provide various geolocated content, etc. Although FIG. 1 illustrates the geographic mapping application 108 as a standalone application, the functionality of the geographic mapping application 108 also can be provided in the form of an online service accessible via a web browser executing on the client device 102, as a plug-in or extension for another software application executing on the client device 102, etc. The geographic mapping application 108 generally can be provided in different versions for different respective operating systems. For example, the maker of the client device 102 can provide a Software Development Kit (SDK) including the geographic mapping application 108 for the Android™ platform, another SDK for the iOS™ platform, etc.

The server 130 may be configured to provide and receive requests for map display animations, generate map display animations, and transmit map display animations to the client device 102. The server 130 includes one or more processors 132 and a memory 134. The memory 134 may be tangible, non-transitory memory and may include any types of suitable memory modules, including random access memory (RAM), read-only memory (ROM), flash memory, other types of persistent memory, etc. The memory 134 stores instructions executable on the processors 132 that make up a map display animation generation module 136, which can process requests for map display animations and generate map display animations. In some implementations, the map display animation generation module 136 may generate map display animations before receiving a request from the client device 102 for such map display animations, and cache the generated map display animations for later retrieval. The cached map display animations may be stored, as will be discussed further in following paragraphs, in the media database 140.

In some implementations, the map display animation generation module 136 may train and store a machine learning model operable to generate map display animations. In some implementations, the machine learning model is a generative adversarial network (GAN) including two neural networks, a generator network and a discriminator network.

In other implementations, the map display animation generation module 136 generates the map display animations. For example, the map display animation generation module 136 may obtain background imagery, such as satellite imagery, street level imagery, hybrid satellite/street level imagery, or two-dimensional map data for a geographic area. The map display animation generation module 136 may also obtain condition data for the geographic area, such as current condition data indicative of current conditions as the geographic area. Then the map display animation generation module 136 may generate virtual objects based on the condition data, such as virtual vehicles, virtual people, virtual lighting, virtual clouds, virtual rain, virtual snow, virtual ice, virtual buildings, virtual windows, virtual animals, etc., and may combine the virtual objects and the background imagery to generate the animation.

The server 130 can be communicatively coupled to databases 140, 142, 144, and 146, storing user generated content, non-user generated media, map display animations, and geospatial information, respectively. Although depicted as separate databases, the information stored in the databases could be merged into fewer databases, or into a single database. These databases 140, 142, 144, and 146 may provide the background imagery or information for generating the background imagery for geographic areas, and/or may provide condition data for generating virtual objects.

The user generated content (UGC) database 140 may include user generated geographic image files, geographic video files, and geographic audio files. The UGC may be crowdsourced. The UGC may be tagged with metadata. The UGC may be tagged with the geographic area where the UGC was captured (geotagged) or the time when the UGC was captured. The UGC may be received by the UGC database 140 from the geographic mapping applications 108 of one or several client devices 102 in response to a request from the UGC database 140 for the UGC or due to the geographic mapping applications 108 providing the geographic files without a request from the UGC database 140. For example, a user of the geographic mapping application 108 may use the camera 120 of their client device 102 to capture a geographic image of a street corner, with the geographic image of the street corner captured in a geographic image file embedded with metadata including the geographic area where the geographic image was captured. In this example, the user may then upload the geographic image file, through the geographic mapping application 108, to the server 130 or to the media database.

The media database 142 may include non-user generated geographic image files, geographic video files, or geographic audio files, or other non-user generated geographic files. The non-user generated geographic files may be files captured, created, purchased, or otherwise obtained for storage in the media database 142. For example, the non-user generated content geographic files could include audio files of generic birds chirping or trees rustling in the wind. The non-user generated geographic files could also include geographic image files captured of a geographic area from a street-level perspective, bird's-eye perspective, a satellite perspective, etc.

The mapping database 144 may include geospatial information including schematic and satellite data storing street and road information, topographic data, satellite imagery, information related to public transport routes, information about businesses or other points of interest (POI), navigation data such as directions for various modes of transportation, etc. In some implementations, the satellite imagery, street-level imagery, or map representations may include map features, such as roads, buildings, parks, stadiums, airports, bodies of water, mountain ranges, etc., without including people, vehicles, or other entities. The images the server 130 receives from the databases 140 and 142 may include metadata indicating times when and/or geographic areas where the images were captured. The server 130 may receive information from the mapping database 144 (e.g., in response to a request from the server 130 to the mapping database 144 seeking information regarding a particular geographic area) and transmit this information to the client device 102. The geographic mapping application 108 can use the information to display interactive digital maps indicating geographic areas where map display animations are available. As an example, the geographic mapping application 108 operating in the satellite view mode may display satellite view imagery for a geographic area and also display an indication that the geographic area has map display animations available. By interacting with the geographic mapping application 108, a user can navigate through map display animations for geographic areas accessed within the map.

The server 130 may request the geographic files from the UGC database 140, the media database 142, and/or the mapping database 144 to assist in generating map display animations at the map display animation generation module 136.

The map display animation database 146 may include existing map display animations which may have been generated by the server 130 using the map display animation generation module 136. The geographic mapping application 108 may request existing map display animations from the map display animation database 146, either directly or via the server 130. Additionally, the existing map display animations may be used as training data for the machine learning model. In some scenarios, the geographic mapping application 108 may be configured to access the map display animations in the map display animation database 146 while operating in a street-level mode. The street-level mode allows a user to navigate through a virtual environment formed by imagery which may contain map display animations. For example, the geographic mapping application 108 enables a user to navigate through a virtual environment formed by the map display animations, such that the user virtually experiences moving along the path or road from which the street-level images were captured. The street-level imagery may also be presented from the same time of day (e.g., the middle of the day) under the same weather and/or lighting conditions (e.g., sunny conditions) and during the same time of year (e.g., the summer). The map display animation may include virtual objects in the street-level imagery that are animated to reflect the geographic area and current conditions. In other scenarios, the geographic mapping application 108 may be configured to access the map display animations in the map display animation database 146 while operating in a satellite mode, a two-dimensional map representation mode, or any other suitable mode.

In general, the server 130 may receive information related to geographic areas from any number of suitable databases. For example, the server 130 may be coupled to a weather database (not shown) which includes current or average weather data in various geographic areas, a natural disasters database (not shown) including current or common natural disasters that occur in various geographic areas, a traffic database (not shown) including current or average vehicle and/or pedestrian traffic on a road, path, or area in various geographic areas, a crowd database (not shown) including current or average crowd gatherings in various geographic areas, and/or an event database (not shown) including current or average events occurring in various geographic areas.

The map display animation generation module 136 and the animation presentation module 137 can operate as components of a map display animation system. Alternatively, the map display animation system can include only server-side components and simply provide the animation presentation module 137 with instructions to display the map display animations. In other words, map display animation techniques in these embodiments can be implemented transparently to the animation presentation module 137. As another alternative, the entire functionality of the map display animation generation module 136 can be implemented in the animation presentation module 137. For example, the client device 102 may generate the map display animations locally. Additionally or alternatively, the server device 130 may provide condition data and/or geographic data for the geographic area to the client device 102. The client device 102 may then generate the animation based on the condition data and/or geographic data.

In addition to communicating with the databases 140-146, the server 130 can be communicatively coupled to other servers 150, 152, 154, and 156, providing weather data, traffic data, crowd data, and event data, respectively.

The weather server 150 may include current or average weather data in various geographic areas. The weather server may be crowdsourced, received from a governmental organization (i.e., the National Oceanic and Atmospheric Administration—U.S. Department of Commerce), received from local meteorologists (i.e., local weather and news outlets), received from national meteorologists, or received from other weather vendors. The weather data may include information about weather for a geographic area including temperature, humidity, cloud cover, lighting conditions, sunrise time, sunset time, season, climate, wind speed, wind direction, tidal information, air quality, air visibility, pollen levels, depth of snowpack, probability and/or intensity of precipitation including rain, snow, sleet, or hail, probability and/or intensity of storms including thunder storms with or without lightning, hurricanes, tornados, typhoons, rain storms, snow storms, hail storms, ice storms, or tropical storms, astronomical data including phase of the moon, visibility of planets, visibility of stars, or occurrence of eclipses, or other weather and/or meteorological data. The weather data may be tagged with metadata, including the geographic area where the weather data was captured, the regions where the weather data applies, the time when the weather data was captured, or the time when the weather data applies. The weather data may include weather data averaged over extended periods of time, representing the climate of a geographic area. The weather data may be received by the server 130 or the client device 102 from the weather server 150 in response to a request from the server 130 or client device 102, or due to the weather server 150 providing the weather data without request from the server 130 or client device 102. The weather server 150 may receive weather data from the client device 102 in response to a request from the weather server 150 or due to the client device 102 providing the weather data without request from the weather server 150.

The traffic server 152 may include current or average traffic data in various geographic areas. The traffic server may be crowdsourced, received from a governmental organization (i.e., U.S. Department of Transportation), received from local news outlets, received from national news outlets, or received from other traffic vendors. The traffic data may include information for a geographic area about traffic intensity, the states of traffic lights, vehicle speeds, types of vehicles vehicle collisions, road construction, rush-hour traffic, traffic of non-personal vehicles including buses, trains, watercraft, aircraft, etc., pedestrian traffic, bicycle traffic, or other traffic information. The traffic data may be tagged with metadata, including the geographic area where the traffic data was captured, the regions where the traffic data applies, the time when the traffic data was captured, or the time when the traffic data applies. The traffic data may include traffic data averaged over extended periods of time. The traffic data may be received by the server 130 or the client device 102 from the traffic server 152 in response to a request from the server 130 or client device 102, or due to the traffic server 152 providing the traffic data without request from the server 130 or client device 102. The traffic server 152 may receive traffic data from the client device 102 in response to a request from the traffic server 152 or due to the client device 102 providing the traffic data without request from the traffic server 152.

The crowd server 154 may include current or average crowd data in various geographic areas. The crowd data server may be crowdsourced, received from a governmental organization (i.e., the U.S. National Park Service), received from local news outlets, received from national news outlets, or received from other crowd data vendors. The crowd data may include information for a geographic area about crowd intensity, crowd behavior, crowd demographics, or other crowd information. For example, crowd data may include information that a community park has a dense crowd with members of the crowd walking, playing sports, and sitting in the community park. The crowd data may include an indication if proper social distancing for reducing the spread of viruses is possible for the geographic area. The crowd data may also include reviews, ratings, social media descriptions, photos, videos, and/or audio of current crowd conditions to provide an overall level of excitement in the geographic area. The crowd data may be tagged with metadata, including the geographic area where the crowd data was captured, the regions where the crowd data applies, the time when the crowd data was captured, or the time when the crowd data applies. The crowd data may include crowd data averaged over extended periods of time. The crowd data may be received by the server 130 or the client device 102 from the crowd server 154 in response to a request from the server 130 or client device 102, or due to the crowd server 154 providing the crowd data without request from the server 130 or client device 102. The crowd server 154 may receive crowd data from the client device 102 in response to a request from the crowd server 154 or due to the client device 102 providing the crowd data without request from the crowd server 154.

The event server 156 may include current or average event data in various geographic areas. The event server may be crowdsourced, received from local news outlets, received from national news outlets, received from event hosts, or received from other event vendors. The event data may include information for a geographic area about scheduled events including sporting events, political events, music events, art events, education events, professional events, family events, entertainment events, construction events or projects, or other events, including the size of the event, time of the event, how to obtain tickets or admission to the event, geographic area of the event, demographics of the event, category of the event, participants of the event, behavior of participants in the event, or other event information. The event data may include an indication if proper social distancing for reducing the spread of viruses is possible for the geographic area of the event. The event data may include event data averaged over extended periods of time. The event data may be received by the server 130 or the client device 102 from the event server 156 in response to a request from the server 130 or client device 102, or due to the event server 156 providing the event data without request from the server 130 or client device 102. The event server 156 may receive event data from the client device 102 in response to a request from the event server 156 or due to the client device 102 providing the event data without request from the event server 156.

In general, the server 130 may receive information related to geographic areas from any number of suitable servers, web services, etc. For example, the server 130 may be coupled to a user generated content server (not shown) which includes user generated geographic image files, geographic video files, geographic audio files, or other geographic media files, a media server (not shown) including non-user generated geographic image files, geographic video files, or geographic audio files, or other non-user generated geographic files, a natural disasters server (not shown) including current or common natural disasters that occur in various geographic areas, and/or a mapping server (not shown) including geospatial information in various geographic areas.

For simplicity, FIG. 1 illustrates the server 130 as only one instance of a server. However, the server 130 according to some implementations includes a group of one or more server devices, each equipped with one or more processors and capable of operating independently of the other server devices. Server devices operating in such a group can process requests from the client device 102 individually (e.g., based on availability), in a distributed manner where one operation associated with processing a request is performed on one server device while another operation associated with processing the same request is performed on another server device, or according to any other suitable technique. For the purposes of this discussion, the term “server device” may refer to an individual server device or to a group of two or more server devices.

### Example Real-World Condition Data

The server device 130 can be communicatively coupled to databases 140-146 that store information aiding in the generation of map display animations, such as user generated media, non-user generated media, mapping information, or existing map display animations, as described with reference to FIG. 1. The server device 130 may retrieve the data from the databases 140-146 and generate a data table of condition data for geographic areas, such as current condition data.

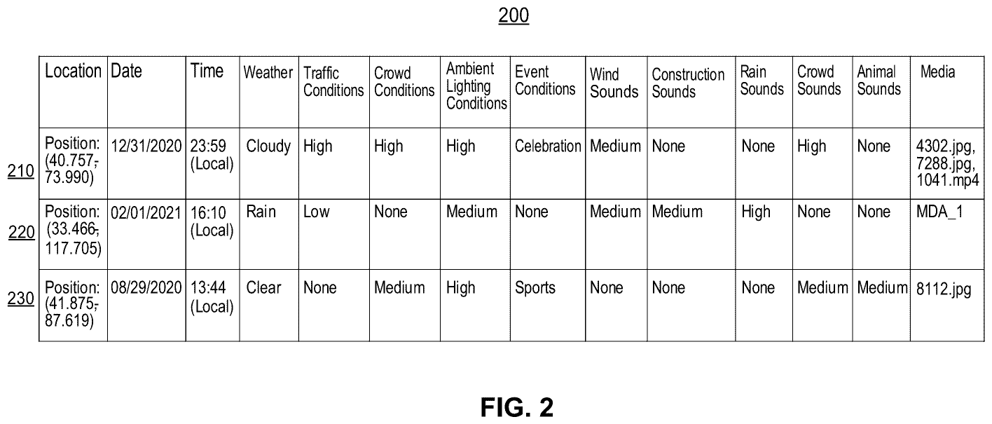

This is described with reference to FIG. 2 which illustrates an example data table 200. The data table 200 includes example current condition data indicative of current conditions of a geographic area including, weather, traffic conditions, crowd conditions, ambient lighting conditions, event conditions, wind sounds, construction sounds, rain sounds, crowd sounds, animal sounds, and media for a defined geographic area, orientation, date, and time.

The data table 200 can store information regarding geographic entities that can be visible when driving (or bicycling, walking, or otherwise moving along a navigation route). For example, the data table 200 can store geographic information for each geographic area and can store one or several media files related to the geographic area. To populate the data table 200 with media files, the server device 130 can receive satellite imagery, photographs, videos, and/or audio submitted by various users, street-level imagery collected by cars equipped with specialized panoramic cameras, street and sidewalk imagery collected by pedestrians and bicyclists, photographs, videos, and/or audio collected by surveillance or security cameras, photographs, videos, and/or audio posted to social media or other online sources, photographs, videos, and/or audio provided by stock photograph or video sources, etc. Similarly, the data table 200 can include descriptions of the geographic area from various sources such as operators of the server device 130, users of the client devices 102, operators of other servers such as 150, 152, 154, or 156, or outside third-parties.

Multiple example entries into the data table 200 are shown. For example, the first entry 210 in the data table 200 includes information to aid in generating a map display animation for a geographic area in Manhattan on New Year's Eve. The first entry 210 indicates cloudy weather conditions, with heavy traffic, large crowds, and a high level of ambient lighting. The lighting data may be obtained from diffuse lighting from the sky, local-source lights, such as vehicle head or tail lights, street lights in the geographic area, illuminated storefronts and signage, or any other suitable light sources. The light sources may be identified by analyzing photographs and/or videos of the geographic area using semantic segmentation and detecting brightness levels of identified street lights, vehicle head or tail lights, storefronts, signage, etc. The light sources may also be identified based on the time of day relative to the sunrise and sunset times in the geographic area and/or the weather conditions in the geographic area, for example as determined from the weather server 150. Additionally, the first entry 210 indicates that a celebration event is taking place in the geographic area. The first entry 210 also include audio information, such as medium wind sounds and large crowd sounds. Finally, the first entry 210 also includes two image files and one video file as media. The image files may be stock photographs of the geographic area. The video file may be, for example, a video captured in Manhattan during the current New Year's Eve, submitted by a user of the client device 102 to the database 200 as UGC. The data stored in the first entry 210 of the data table 200 may be used in generating map display animations, which may include, for example, a street scene of Manhattan at nighttime with animated people celebrating, animated vehicles moving slowly in traffic on the streets, and audio of cheering crowds and wind.

The second entry 220 in the data table 200 includes information to aid in generating a map display animation for a geographic area in California on the Pacific Coast Highway during a rainstorm. The second entry 220 indicates rainy weather conditions without any crowds due to the weather. There may not be any planned events for the geographic area.

Audio information may also be included in the second entry 220. For example, the audio information may include medium wind sounds, medium construction sounds, and high rain sounds. Finally, the second entry 220 includes an existing map display animation (MDA_1) as media. The map display animation may have been created previously for the geographic area during, for example, the last rain storm and may have been saved to the database 200 for later retrieval, thereby reducing computation required to generate the map display animation for this geographic area during a rainy weather. The data stored in the second entry 220 of the data table 200 may be used in generating map display animations, which may include, for example, a street scene of the Pacific Coast Highway during a rainstorm with animated rain falling from dark and cloudy skies, animated cars driving on the highway, animated construction machinery operating, animated trees swaying in the wind, and audio of rain, wind, traffic, and construction.

The third entry 230 in the data table 200 includes information to aid in generating a map display animation for a public park on a weekend. The third entry 230 indicates clear weather conditions, medium crowd conditions, and a high level of ambient lighting. The third entry 230 also indicates that there is a sporting event in the geographic area, which may be based, for example, on information obtained from social media sources indicating a planned game of community soccer.

Audio information may also be included in the third entry 230. For example, the audio information may include medium crowd sound and medium animal sounds. Finally, the third entry 230 also includes a video file and audio file. The audio file may be, for example, audio captured and submitted by a user of the client device 102 to the database 200 as UGC. The data stored in the third entry 230 of the data table 200 may be used in generating map display animations, which may include, for example, a public park scene during a clear, weekend day, with animated people playing soccer, animated crowds watching the soccer game, animated people lounging in grass, animated people walking on trails, animated birds flying, and audio of talking, cheering, and birds chirping.

In general, the data table 200 may receive information related to geographic areas from any number of suitable databases, servers, web services, etc., that may be owned and/or operated by users, government entities, private entities (i.e., news outlets, stock media distributors, map providers, etc.), or other owners and/or operators with information related to geographic areas that may be useful in generating map display animations. For example, the data table 200 may be communicatively coupled to a weather server which includes current or average weather data in various geographic areas, a natural disasters server which includes current or common natural disasters that occur in various geographic areas, a traffic server which includes current or average vehicle and/or pedestrian traffic on a road, path, or area in various geographic areas, a crowd server which includes current or average crowd gatherings in various geographic areas, an event server which includes current or average events occurring in various geographic areas, user generated content server which includes user generated geographic image files, geographic video files, geographic audio files, or other geographic media files, a media server which includes non-user generated geographic image files, geographic video files, or geographic audio files, or other non-user generated geographic files, and/or a mapping server including geospatial information in various geographic areas.

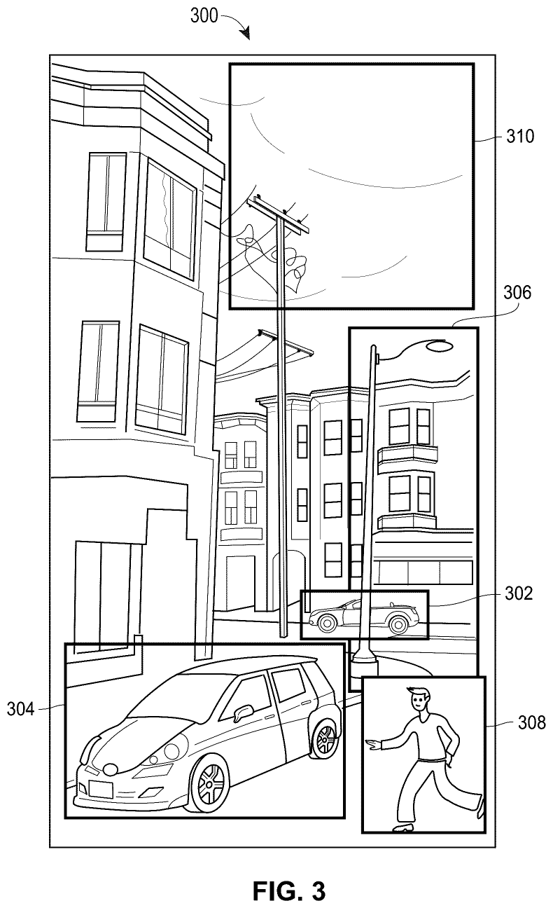

In some implementations, the condition data for a geographic area may be identified by analyzing images or video clips of the geographic area, such as the UGC files or media files mentioned above. Such images or video clips of the geographic area may be “recent” in that they were previously captured by the client device 102 (using the camera 120, the microphone 122 or otherwise) within a threshold duration before the transmission of the request for an animation of the geographic area. The threshold duration may any reasonable duration, such as 1 hour, 30 minutes, 10 minutes etc. For example, the images or video clips may be obtained from client devices 102 of users executing geographic mapping application 108 that provide the images or video clips to the server 130. FIG. 3 illustrates example street-level imagery 300, which may be an image or video clip of a geographic area, which can be analyzed by the system of FIG. 1 for example, using semantic segmentation to identify current conditions at the geographic area. Beneficially, by identifying condition data based on images or video clips captured by the client device 102, the condition data is more accurate and representative of the actual conditions of the geographic area at that time.

The server 130 analyzes the street-level imagery 300 using object recognition and/or semantic segmentation techniques to identify objects within the street-level imagery 300 and determine the object type of each object. For example, the server 130 analyzes the street-level imagery 300 to identify a first car 302, a second car 304, a street light 306, a pedestrian 308, and clouds 310. The server 130 then determines the positions of each object 302-310 within the street-level imagery. For example, the server 130 may determine the positions of each object 302-310 within the real-world imagery by identifying a view frustum of a virtual camera depicting the street-level imagery and mapping geographic areas in the view frustum to pixels within the street-level imagery. The server 130 may then identify current conditions of the street scene based on the identification of objects within the street-level imagery 300. For example, the server 130 may identify the traffic conditions to be low, based upon the identification of only the first car and the second car in the panoramic street-level imagery 300, or the server 130 may identify the ambient light conditions to be medium based upon the identification of clouds 310 and the identification of the street light 306 as not turned on.

Still further, the server 130 may identify current conditions of the street scene for different orientations for viewing the street scene. For example, if the user is traveling east, the server 130 may identify traffic conditions and/or ambient lighting conditions for viewing the street scene from the east. To separately identify current conditions of the street scene, the server 130 may obtain street-level imagery from multiple perspectives from multiple orientations or geographic areas. The server 130 may then analyze the street-level imagery from the perspective corresponding to the orientation the user is facing to identify current conditions of the street scene.

In some implementations, the map display animation generation module 136 may identify objects within images or video clips using machine learning techniques. More specifically, the map display animation generation module 136 may generate a machine learning model using images or video clips labeled with the object types included in the images or video clips as training data. In other implementations, the map display animation generation module 136 may generate the machine learning model using template objects of various object types (e.g., a person, a vehicle, etc.).

The machine learning model may include a set of features for each object type, such as a first set of features for a vehicle, a second set of features for a person, a third set of features for a street light, a fourth set of features for clouds, etc. Then the map display animation generation module 136 may obtain and identify features and objects in the UGC files or media files by comparing the features of unknown objects in the UGC files or media files to the features of the template objects. For example, semantic segmentation may be used to identify cars, light posts, pedestrians, buildings, weather, events, etc. The machine learning techniques may include linear regression, polynomial regression, logistic regression, random forests, boosting, nearest neighbors, Bayesian networks, neural networks, support vector machines, GANS, or any other suitable machine learning technique.

In some embodiments, the template features may be compared to the features for an object using a nearest neighbors algorithm. The nearest neighbors algorithm may identify template features which are the closest to the features of the object by creating numerical representations of the features to generate feature vectors, such as a pixel width and height of an object, RGB pixel values for the object, color gradients within the object, etc. The numerical representations of the features or feature vectors of the object may be compared to the feature vectors of template objects to determine a vector distance between the features of the object and each template object. The object type for an object based on the amount of similarity, or the vector distance in the nearest neighbors algorithm, between the features for the object and the features for template objects that represent a particular object type may then be determined. The map display animation generation module 136 may repeat this process for multiple objects within the street-level imagery.

### Example Map Display Animations

As mentioned above, when the geographic mapping application 108 transmits a request for an animation of the geographic area, the map display animation generation module 136 obtains condition data indicative of current conditions within the geographic area, such as the condition data in the database 200. Additionally, the map display animation generation module 136 may obtain map data for the geographic area, such as satellite imagery, street-level imagery, hybrid satellite/street level imagery, or a two-dimensional map representation of the geographic area, for example from the mapping database 144.

Then the map display animation generation module 136 may generate virtual objects which represent the current conditions without presenting live photographs or video of the geographic area. For example, the virtual objects may include virtual vehicles, virtual people, virtual lighting, virtual clouds, virtual rain, virtual snow, virtual ice, virtual buildings, virtual windows, virtual animals, virtual construction sounds, virtual crowd noise, virtual animal sounds, etc. The type, number, behavior, appearance, etc. of the virtual objects may be selected based on the current conditions of the geographic area. Then the map display animation generation module 136 may combine the virtual objects with the satellite imagery, street level imagery, hybrid satellite/street level imagery, or two-dimensional map data to generate an animation of the geographic area. The animation may be a video clip where the virtual objects change position or other attributes during the video clip. For example, vehicles may travel on roads at speeds that reflect current traffic conditions, crowds of people may move at speeds that reflect current crowd conditions and/or in a manner that reflects current levels of excitement (e.g., by yelling, cheering, running, dancing, etc.), lighting conditions may change, clouds may form and/or dissipate, rain or snow may fall, etc. The animation may also include audio representative of the current sounds within the geographic area.

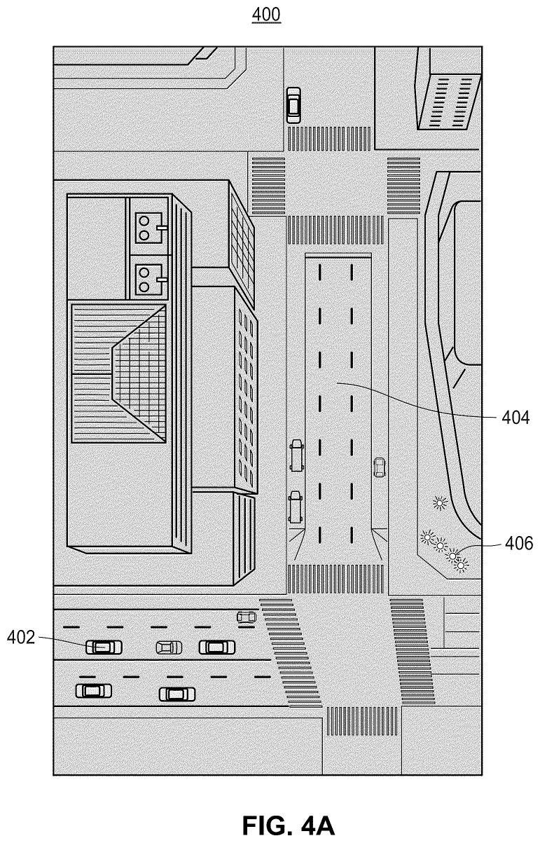

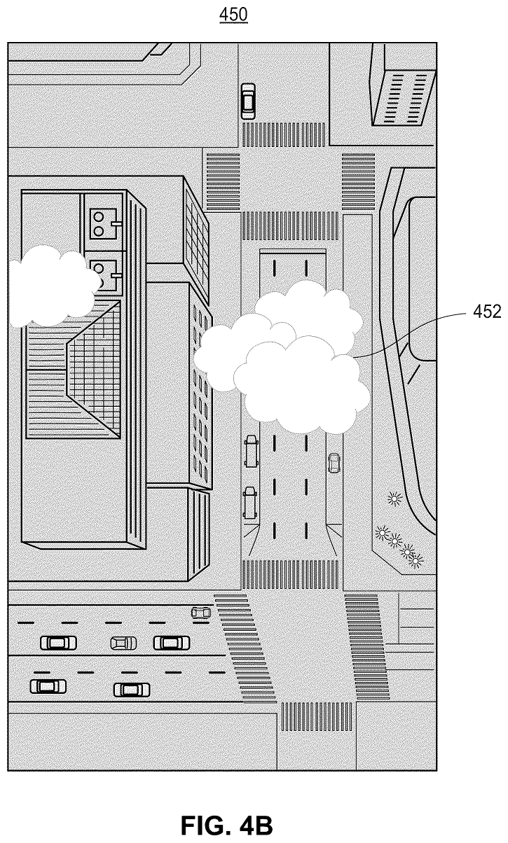

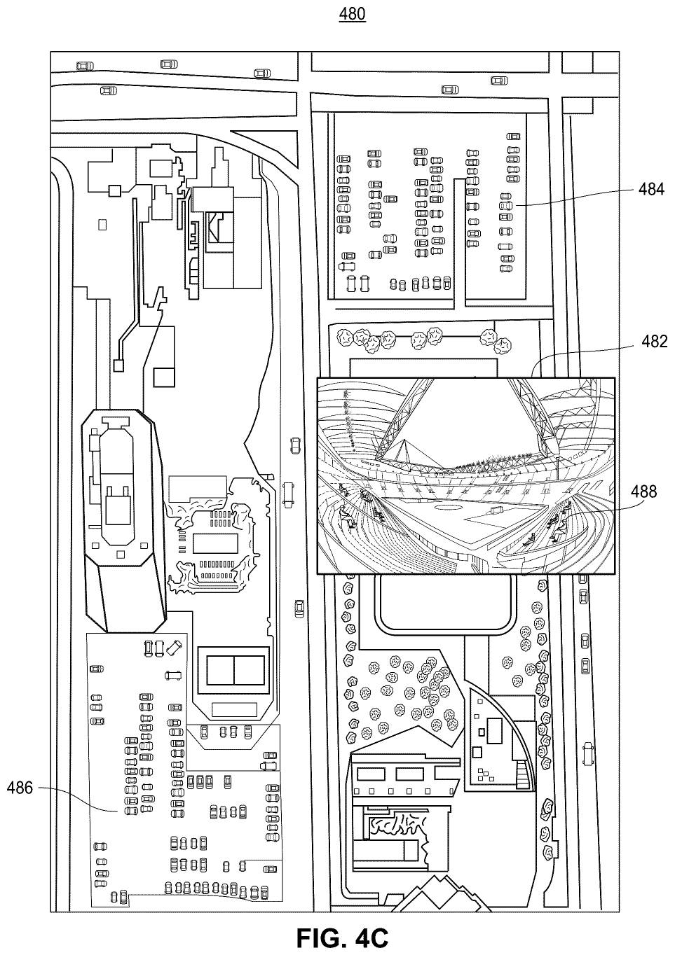

FIGS. 4-8 illustrate example displays of animations 400-800 which may be generated by the map display animation generation module 136 and presented by the geographic mapping application 108 on the client device 102, via the animation presentation module 137. While the displays 400-800 are shown as still images, this is for ease of illustration only. The geographic mapping application 108 may present video clips (e.g., 10 second video clips, 30 second video clips, or video clips of any suitable length.) with moving objects, such as moving vehicles, moving pedestrians or crowds, rain, snow, changing light conditions, etc. The video clips also may include an audio component.

In some implementations, the geographic mapping application 108 on a user's client device 102 presents a map display of a geographic area. The map display may be a two-dimensional map representation, a satellite view, a street level view, a hybrid satellite/street level view, or any other suitable view of the geographic area. Additionally, the geographic area may be selected by the user or may be a default geographic area, such as the user's current location. In any event, geographic mapping application 108 may receive a request to present an animation of the geographic area from the user.

For example, the user may perform a long press gesture or may provide any other suitable gesture input indicating that the user would like to view an animation of the geographic area. In other implementations, the map display animation system may automatically determine to provide the animation in response to a triggering condition. The triggering condition may be that a particular event is occurring within the geographic area, such as a sporting event or concert. The triggering condition may also be a news update in the geographic area such as a vehicle crash which is causing a traffic jam in the geographic area, or may be any other suitable triggering condition. In any event, the geographic mapping application 108 may then present an animation of the geographic area in response to the user's request or the triggering condition.

FIGS. 4A-4C illustrate example displays of animations 400, 450, 480 from a satellite view. The example display 400 as shown in FIG. 4A depicts a satellite view, at night, of a geographic area. The satellite view of the buildings and roads may be obtained from the mapping database 144 which includes a general satellite view during the day and in clear weather conditions of the buildings and roads in the geographic area without any vehicle, people, or other entities.

The map display animation generation module 136 obtains current condition data indicating that it is nighttime, that several street lights are lit up, that there is moderate traffic, and the weather conditions are clear. Accordingly, the map display animation generation module 136 generates virtual objects, such as virtual vehicles 402, a virtual night sky 404, virtual lit street lights 406, etc. in accordance with the current condition data. For example, the virtual vehicles may be stock images of vehicles and are not the real-world vehicles currently in the geographic area. The map display animation generation module 136 then overlays the virtual objects on the satellite view. Additionally, the map display animation generation module 136 generates the animation such that the virtual vehicles move over time. The virtual vehicles may move at speeds that reflect the current traffic conditions in the geographic area. For example, if the speed limit on the road is 35 mph and there is heavy traffic, the virtual vehicles may travel at 10 mph or 15 mph in the animation 400. If there is light traffic, the virtual vehicles may travel at 40 mph in the animation 400. Moreover, the states of traffic lights may change in the animation and the virtual vehicles may move in such a manner that they comply with traffic regulations. For example, the virtual vehicles may stop at red lights or stop signs and/or may follow post speed limits.

Additionally, the animation 400 may include sounds, such as traffic sounds (e.g., cars honking), construction sounds, animal sounds etc. The sounds in the animation 400 do not include the actual sounds in the geographic area, and instead may be obtained from a library of pre-stored traffic sounds, construction sounds, animal sounds, etc.

FIG. 4B illustrates another example display 450 of an animation similar to the animation 400 as shown in FIG. 4A. However, in the animation 450, the current conditions are cloudy, and accordingly, virtual clouds 452 are overlaid on the satellite view.

FIG. 4C illustrates yet another example satellite display 480 of an animation. The geographic area for the display 480 include a stadium 482 and parking lots 484, 486. As in the displays 400, 450, the vehicles and people included in the display 480 are virtual vehicles and virtual people 488 and are not the real-world vehicles or people currently in the geographic area. The map display animation generation module 136 obtains current condition data indicating the crowd size and/or crowd data and then determines the number of virtual vehicles and virtual people 488 to include in the parking lots 484, 486 and stadium 482, respectively. The map display animation generation module 136 generates the animation such that the virtual people 488 move over time. For example, the virtual people 488 may wave their hands, dance, or cheer in the stadium 482 in a manner that reflects current levels of excitement. The virtual people 488 may include photorealistic images of people or non-photorealistic images of people, such as cartoons, stick figures, etc.

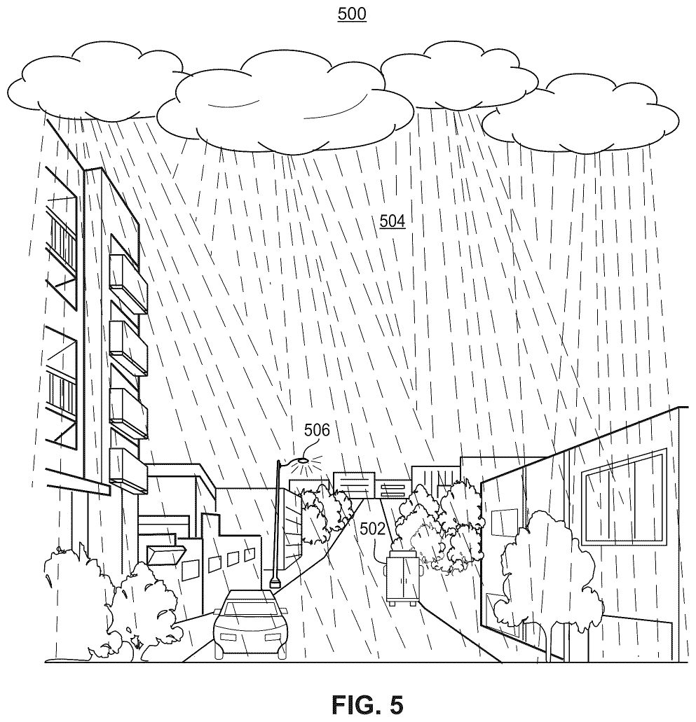

FIG. 5 illustrates an example display 500 of an animation from a street level view. The street level view of the buildings and roads may be obtained from the mapping database 144 which includes a general street level view during the day and in clear weather conditions of the buildings and roads in the geographic area without any vehicle, people, or other entities. The map display animation generation module 136 obtains current condition data indicating that there is very light traffic, it is raining, and that there is a low level of ambient lighting from a street light. Accordingly, the map display animation generation module 136 generates a few virtual vehicles 502, virtual rain clouds 504, and lights up a street light 506. The animation 500 then depicts rain falling down.

Additionally, the animation 500 may include rain sounds. The sounds in the animation 500 do not include the actual sounds in the geographic area, and instead may be obtained from a library of pre-stored rain sounds.

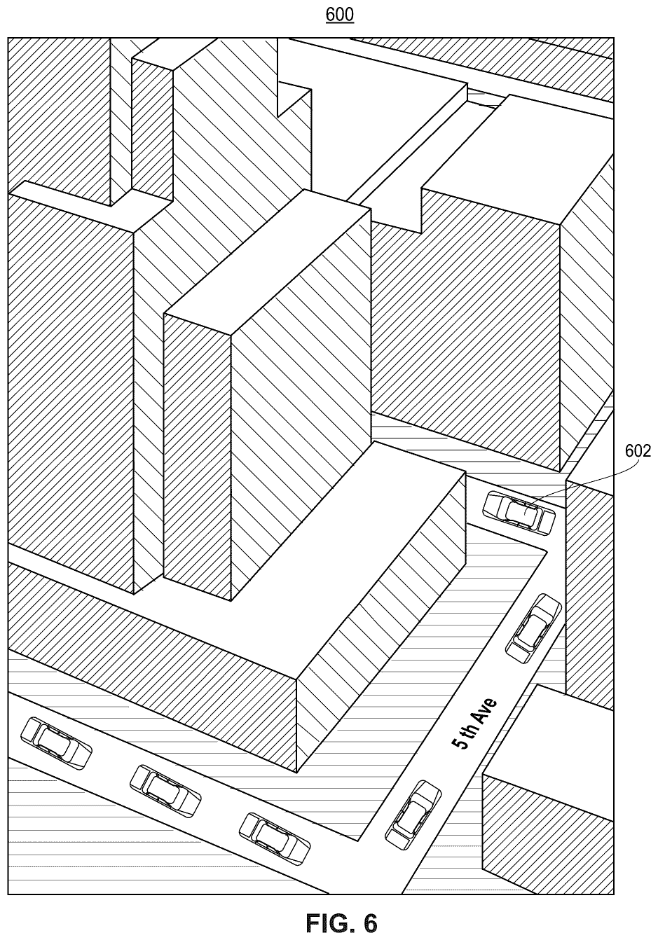

FIG. 6 illustrates an example display 600 of an animation from a hybrid satellite/street level view using photorealistic imagery. The hybrid satellite/street level view is not from the street level but also is not from directly above the geographic area. Instead, the hybrid satellite/street level view is presented at about a 45 degree angle. The hybrid satellite/street level view of the buildings and roads may be obtained from the mapping database 144 which includes a general street level view during the day and in clear weather conditions of the buildings and roads in the geographic area without any vehicle, people, or other entities. The map display animation generation module 136 obtains current condition data indicating that there is moderate traffic. Accordingly, the map display animation generation module 136 generates virtual vehicles 602, and the animation 600 depicts the virtual vehicles 602 moving at moderate speeds.

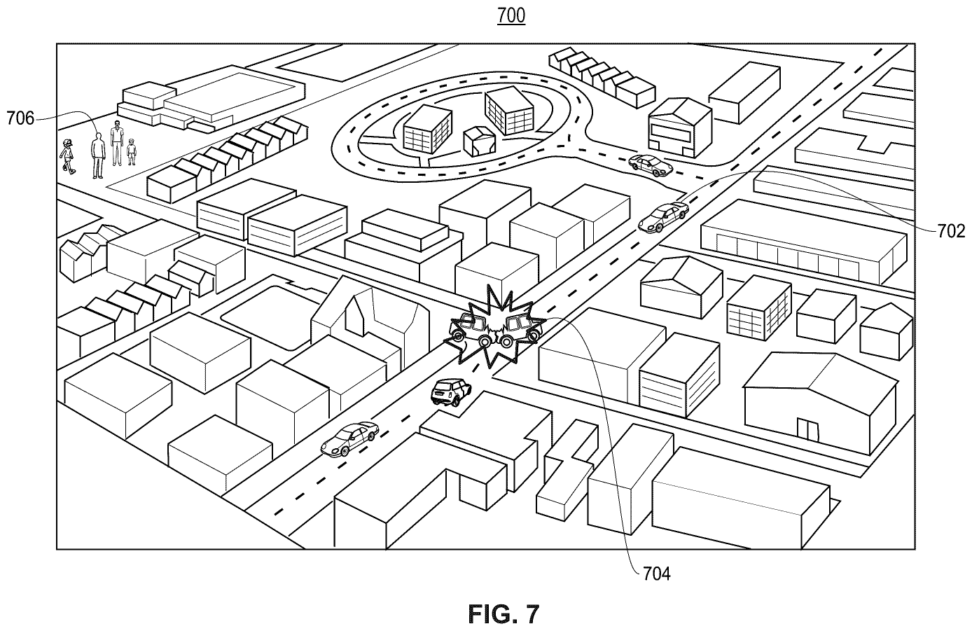

FIG. 7 illustrates another example display 700 of an animation from a hybrid satellite/street level view. While the example display 600 includes photorealistic imagery, the example 700 includes non-photorealistic imagery. In this implementation, the map display animation generation module 136 may not obtain the hybrid satellite/street level view of the buildings and roads from the mapping database 144. Instead, the map display animation generation module 136 may obtain map data from the mapping database 144, and then may generate non-photorealistic imagery of buildings, roads, and other geographic features based on the map data.

Additionally, the map display animation generation module 136 may generate the virtual objects, such as virtual vehicles 702, 704 and virtual people 706 in a non-photorealistic manner. For example, the virtual vehicles 702, 704, and virtual people 706 may be cartoons.

Furthermore, the current condition data may indicate that there was a vehicle crash in the geographic area. Accordingly, the animation 700 may include virtual vehicles 704 crashing into each other or that have crashed into each other. This may indicate to the user that there is likely to be traffic in the area due to the crash.

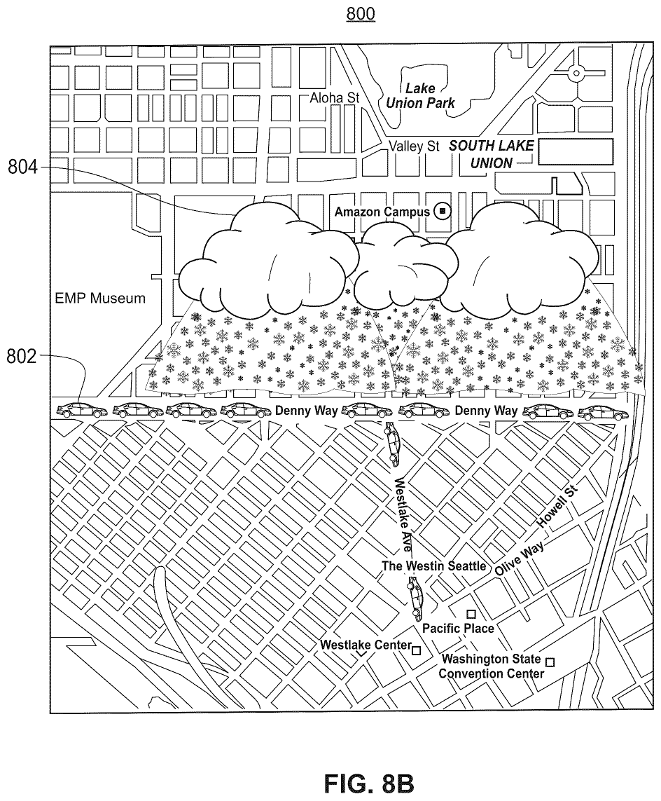

FIG. 8 illustrates an example animation 800 of a two-dimensional map display of the geographic area. The two-dimensional map display may be obtained from the mapping database 144 which includes a general map representation of the geographic area. The map display animation generation module 136 obtains current condition data indicating that it is snowing, and that there is heavy traffic on Denny Way and moderate traffic on Westlake Avenue. Accordingly, the map display animation generation module 136 generates virtual objects, such as virtual vehicles 802, and virtual clouds 804. The map display animation generation module 136 then overlays the virtual objects on the two-dimensional map representation. The animation 800 then depicts snow falling down.

Additionally, the map display animation generation module 136 generates the animation such that the virtual vehicles move over time. The virtual vehicles may move at speeds that reflect the current traffic conditions in the geographic area. For example, if the speed limit on the road is 35 mph and there is heavy traffic, the virtual vehicles may travel at 10 mph or 15 mph in the animation 800. If there is light traffic, the virtual vehicles may travel at 40 mph in the animation 800. Moreover, the states of traffic lights may change in the animation and the virtual vehicles may move in such a manner that they comply with traffic regulations. For example, the virtual vehicles may stop at red lights or stop signs and/or may follow post speed limits.

The displays 400-800 shown in FIGS. 4-8 are example images which may be included in animations, for ease of illustration only. The client device 102 may present any suitable animations of geographic areas which reflect the current conditions in the geographic areas. More specifically, the client device 102 may present animations of satellite views, street level views, hybrid satellite/street level views, or two-dimensional map representations using photorealistic or non-photorealistic imagery. The client device 102 may also overlay any suitable photorealistic or non-photorealistic virtual objects on the satellite views, street level views, hybrid satellite/street level views, or two-dimensional map representations to reflect the current conditions in the geographic areas.

### Example Methods for Generating Map Display Animations

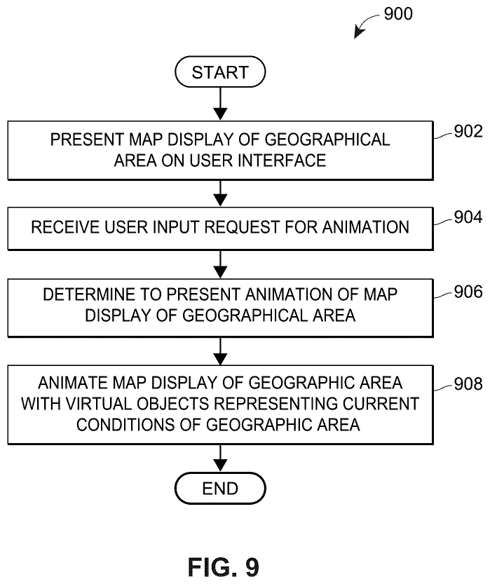

FIG. 9 illustrates a flow diagram of an example method 900 for presenting an animation of a geographic area based on current conditions within the geographic area. The method can be implemented in a set of instructions stored on a computer-readable memory and executable at one or more processors of the client device 102. For example, the method 900 can be implemented by the geographic mapping application 108, and more specifically, the animation presentation module 137.

At block 902, a map display of a geographical area is presented on a user interface of a client device 102. The map display may include street-level imagery of the geographic area, topographical imagery of the geographical area, satellite imagery of the geographic area, two-dimensional map imagery, urban transit imagery of the geographic area, traffic imagery of the geographic area, or other map display imagery of the geographic area. The map display imagery may be presented with navigation directions which may include maneuvers at corresponding geographic areas along a route, such as turn left, turn right, continue straight, etc. To assist the user in identifying the geographic areas for performing the maneuvers, the set of navigation directions may refer to visual aids, such as street signs, building signs, etc., proximate to the geographic areas for performing the maneuvers.

At block 904, a request is received for an animation of the geographic area. The request may be a long press, a zoom gesture such as a pinch or pull gesture, a clicking input, a double tap gesture, a typed input, a selection, or any other input indicating the request to animate the geographic area. In some implementations, the user may perform the gesture at a particular location on the map display, where the location of the gesture indicates the geographic area for the request. For example, if the map display is a two-dimensional map display of New York City, and the user performs a long press gesture over Manhattan, the request may be for an animation of Manhattan. The user may also perform zoom or pan gestures to display a particular geographic area in the map display or enter a request for a particular geographic area. After the particular geographic area is presented in the map display, the user may perform the gesture-based input, such as a long press, to request an animation of the particular geographic area.

At block 906, in response to receiving the request, the animation presentation module 137 may determine to present an animation of the geographic area. For example, the animation presentation module 137 may transmit a request to the server 130 for audiovisual data or an animation of the geographic area, and may receive the animation from the server 130 in response to the request. In other implementations, the server 130 may provide audiovisual or animation data for generating the animation, such as vector graphics data, and the animation presentation module 137 may generate the animation based on the animation data. In yet other implementations, the server 130 may provide condition data and/or geographic data for generating the animation, and the animation presentation module 137 may generate the animation based on the condition data and/or geographic data. For example, the geographic data may include geographic data for roads, buildings, parks, stadiums, airports, bodies of water, mountain ranges, and/or other map features in the geographic area.

In yet other implementations, the animation presentation module 137 may automatically determine to provide the animation without request in response to a triggering condition. The triggering condition may be that a particular event is occurring within the geographic area, such as a sporting event or concert. The triggering condition may also be a news update in the geographic area such as a vehicle crash which is causing a traffic jam in the geographic area, or may be any other suitable triggering condition. For example, the server 130 may identify the triggering event and automatically provide the animation or animation data to the animation presentation module 137 without receiving a request from the client device 102. The animation presentation module 137 may then automatically determine to present the animation without receiving a request from the user.

At block 908, the animation presentation module 137 animates the geographic area in the map display, for example, using the animation or animation data from the server 130. The animation may include virtual objects representing current conditions of the geographic area combined with background imagery for the geographic area. The animation may be a video which may or may not include audio. The virtual objects may represent the current conditions at the geographic area without presenting live photographs or video of the geographic area. The virtual objects may be photorealistic and/or non-photorealistic representations which look like the real-world objects. The background imagery may include satellite imagery, street-level imagery, or a map representation of the geographic area. In some implementations, the satellite imagery, street-level imagery, or map representation may include map features, such as roads, buildings, parks, stadiums, airports, bodies of water, mountain ranges, etc., without including people, vehicles, or other entities. The animation may be presented from the same time of day, under the same weather and/or lighting conditions, and during the same time of year as the current conditions at the geographic area.

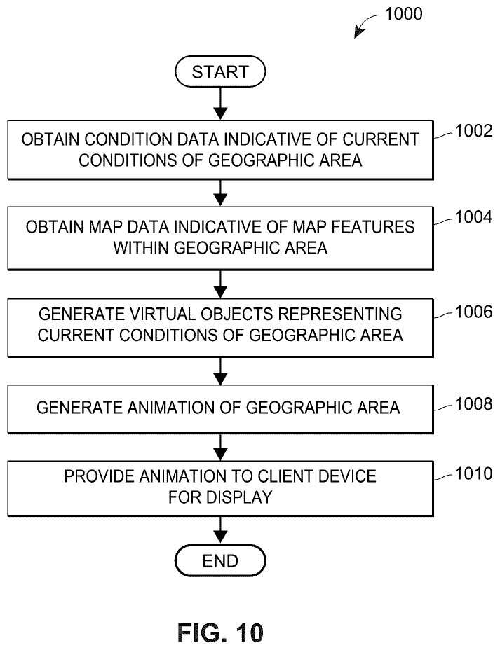

FIG. 10 illustrates a flow diagram of an example method 1000 presenting an animation to a client device for display. The method can be implemented in a set of instructions stored on a computer-readable memory and executable at one or more processors of the server 130. For example, the method can be implemented by the map display animation generation module 136.

At block 1002, condition data indicative of conditions of a geographic area is obtained. The conditions may be current conditions of the geographic area, which may include traffic data indicative of current traffic conditions at the geographic area, crowd condition data indicative of crowd conditions at the geographic area, weather data indicative of current weather conditions at the geographic area, lighting data indicative of ambient light at the geographic area, seasonal data indicative of the state of trees and/or other foliage in the geographic area, ambient sound data indicative of ambient sounds within the geographic area, such as wind, rain, traffic sounds, constructions sounds, crowd noise, animal sounds, etc. As previously discussed, the condition data for a geographical area may be identified by analyzing images or video clips of the geographic area captured by the client device 102. The conditions may be the current conditions of the geographic area at the time the condition data is obtained, the conditions at a predicted time of arrival by a user to the geographic area based on a navigation route, the conditions at a desired time as requested by the user, or a desired condition or conditions as requested by the user. In the case of the conditions being conditions at a predicted time of arrival by a user to the geographical area based on a navigation route, block 1002 may first include determining a predicted arrival time of the user to the geographical area based on the navigation route, and then obtaining condition data indicative of conditions of the geographic area at the predicted arrival time. Beneficially therefore, in this scenario the provided animation can inform a user of the conditions of a future arrival location.

At block 1004, map data indicative of map features of a geographic area is obtained. The map features of the geographic area may include roads, buildings, parks, stadiums, airports, bodies of water, mountain ranges, etc., without the including of people, vehicles, or other entities. The map data may include background imagery for the animation, such as satellite imagery, street-level imagery, or a two-dimensional map representation.

At block 1006, virtual objects representing current conditions of a geographic area are generated. The virtual objects may include virtual vehicles, virtual people, virtual lighting, virtual clouds, virtual rain, virtual snow, virtual ice, virtual buildings, virtual windows, virtual animals, virtual construction sounds, virtual crowd noise, virtual animal sounds, etc. The virtual objects may be based on the current conditions of the geographic area. For example, the type, number, behavior, appearance, etc. of virtual objects may be based on the current conditions of the geographic area. The virtual objects may be photorealistic representations which look like the real-world objects. Additionally or alternatively, the virtual objects may include non-photorealistic representations of the objects which include abstraction and artistic stylization that are visually comparable to renderings produced by a human artist.

At block 1008, an animation of a geographic area is generated. The animation may be based on or include the current conditions of the geographic area, the map features of the geographic area, and the virtual objects of the geographic area. The map display animation generation module 136 may apply the virtual objects to the background imagery to generate the animation of the geographic area which depicts current conditions at the geographic area.

At block 1010, the animation of the geographic area is provided to a client device 102 for display. The client device may display the animation via a geographic mapping application 108. By interacting with the geographic mapping application 108, the user can navigate through animations for geographic areas accessed within the map display.

The present technique thus provides an improved interface between a user and a geographic mapping application by the generation of animations depicting the current conditions of a geographic area. These animations may be bespoke to a given user's situation, since, as exemplified in embodiments, the geographic area, route, planned maneuvers, speed, preferences, lighting, weather conditions, etc. of a given user may all be taken into account in determining the animation presented to the client display. These animations may be generated automatically for any navigation route, any given geographic area of the user, or any geographic area of interest of the user. These animations improve the user's ability to assess the current appearance and/or feel of the geographic area without compromising the privacy of people, vehicles, and/or other entities in the geographic area. These animations can improve the technical field of vehicle navigations through improving the efficiency of navigation for the user by reducing network traffic for navigation. For example, a user may view an animation of a geographic area to determine the current appearance and/or feel of a first geographic area, and, based on the animation, decide, prior to requesting a navigational route for the first geographic area, to not to visit the first geographic area and instead visit only a second geographic area, thereby reducing the number of navigational routes requested by the user. Furthermore, the improved ability to assess appearance and/or feel of the geographic area helps provide easier and safer navigation for all users.

### Additional Considerations

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter of the present disclosure.

Additionally, certain embodiments are described herein as including logic or a number of components, modules, or mechanisms. Modules may constitute either software modules (e.g., code stored on a machine-readable medium) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term hardware should be understood to encompass a tangible entity, be that an entity that is physically constructed, permanently configured (e.g., hardwired), or temporarily configured (e.g., programmed) to operate in a certain manner or to perform certain operations described herein. As used herein “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The methods 900, 1000 may include one or more function blocks, modules, individual functions or routines in the form of tangible computer-executable instructions that are stored in a non-transitory computer-readable storage medium and executed using a processor of a computing device (e.g., a server device, a personal computer, a smart phone, a tablet computer, a smart watch, a mobile computing device, or other client computing device, as described herein). The methods 900, 1000 may be included as part of any backend server (e.g., a map data server, a navigation server, or any other type of server computing device, as described herein), client computing device modules of the example environment, for example, or as part of a module that is external to such an environment. Though the figures may be described with reference to the other figures for ease of explanation, the methods 900, 1000 can be utilized with other objects and user interfaces. Furthermore, although the explanation above describes steps of the methods 900, 1000 being performed by specific devices (such as a server device 130 or client device 102), this is done for illustration purposes only. The blocks of the methods 900, 1000 may be performed by one or more devices or other parts of the environment.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single geographic area (e.g., within a home environment, an office environment or as a server farm), while in other embodiments the processors may be distributed across a number of geographic areas.

The one or more processors may also operate to support performance of the relevant operations in a “cloud computing” environment or as SaaS. For example, as indicated above, at least some of the operations may be performed by a group of computers (as examples of machines including processors), these operations being accessible via a network (e.g., the Internet) and via one or more appropriate interfaces (e.g., APIs).

Still further, the figures depict some embodiments of the example environment for purposes of illustration only. One skilled in the art will readily recognize from the following discussion that alternative embodiments of the structures and methods illustrated herein may be employed without departing from the principles described herein.

Upon reading this disclosure, those of skill in the art will appreciate still additional alternative structural and functional designs for presenting map display animations through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

1. A method for presenting an animation of a geographic area based on current conditions within the geographic area, the method comprising:
presenting, by one or more processors via a user interface, a map display of a geographic area;
determining, by the one or more processors, to present an animation of the geographic area; and
animating, by the one or more processors via the user interface, the map display of the geographic area using virtual objects overlaid on the map display which represent current conditions at the geographic area.

2. The method of claim 1 or 2, wherein the map display of the geographic area is animated without presenting a live video of the geographic area.

3. The method of claim 1, wherein animating the map display of the geographic area further includes:
presenting, by the one or more processors via a speaker, audio representing current ambient sounds within the geographic area.

4. The method of claim 3, wherein the current ambient sounds within the geographic area include at least one of:
wind within the geographic area,
traffic sounds within the geographic area,
construction sounds within the geographic area,
rain within the geographic area,
crowd noise within the geographic area, or
animal sounds within the geographic area.

5. The method of claim 1, wherein the current conditions of the geographic area include at least one of:
current weather conditions at the geographic area,
current traffic conditions at the geographic area,
current crowd conditions at the geographic area, or
current ambient lighting conditions at the geographic area, or
current event conditions at the geographic area.

6. The method of claim 1, wherein determining to present an animation of the geographic area includes determining, by the one or more processors, to present the animation of the geographic area in response to receiving gesture-based input indicating a request for the animation of the geographic area.

7. The method of claim 1, further comprising:
transmitting, by the one or more processors to a server device, a request for animation data for generating the animation;
receiving, by the one or more processors from the server device, the animation data in response to the request; and
animating, by the one or more processors, the map display of the geographic area based on the received animation data.

8. The method of claim 1, wherein animating the map display of the geographic area includes presenting at least one of:
photorealistic street-level imagery of the geographic area,
photorealistic satellite imagery of the geographic area, or
a non-photorealistic two-dimensional map display of the geographic area.

9. A client device for presenting an animation of a geographic area, the client device comprising:
a user interface;
one or more processors; and
a non-transitory computer-readable memory coupled to the user interface and the one or more processors and storing instructions thereon that, when executed by the one or more processors, cause the client device to:
present, via the user interface, a map display of a geographic area;
determine to present an animation of the geographic area; and
animate, via the user interface, the map display of the geographic area using virtual objects overlaid on the map display which represent current conditions at the geographic area.

10. The client device of claim 9, wherein the map display of the geographic area is animated without presenting a live video of the geographic area.

11. The client device of claim 9 or 10, wherein to animate the map display of the geographic area, the instructions cause the client device to:
present, via a speaker, audio representing current ambient sounds within the geographic area.

12. The client device of claim 11, wherein the current ambient sounds within the geographic area include at least one of:
wind within the geographic area,
traffic sounds within the geographic area,
construction sounds within the geographic area,
rain within the geographic area,
crowd noise within the geographic area, or
animal sounds within the geographic area.

13. The client device of claim 9, wherein the current conditions of the geographic area include at least one of:
current weather conditions at the geographic area,
current traffic conditions at the geographic area,
current crowd conditions at the geographic area, or
current ambient lighting conditions at the geographic area, or
current event conditions at the geographic area.

14. A method for generating an animation of a geographic area based on current conditions within the geographic area, the method comprising:
obtaining, by one or more processors, condition data indicative of current conditions within a geographic area;
obtaining, by the one or more processors, map data indicative of map features within the geographic area;
generating, by the one or more processors, one or more virtual objects which represent the current conditions of the geographic area based on the condition data;
generating, by the one or more processors, an animation of the geographic area based on the map data and the one or more virtual objects; and
providing, by the one or more processors, the animation to a client device for display.

15. The method of claim 14, wherein the animation of the geographic area does not include a live video of the geographic area.

16. The method of claim 14, wherein obtaining condition data indicative of current conditions of a geographic area includes at least one of:
obtaining, by the one or more processors, the condition data from crowdsourced data from a plurality of client devices in the geographic area indicative of traffic conditions or crowd size in the geographic area;
obtaining, by the one or more processors, current images of the geographic area from at least one client device for identifying crowd size, traffic conditions, weather conditions, or ambient lighting; or
obtaining, by the one or more processors, the condition data from third-party services indicating weather conditions, events, or traffic conditions in the geographic area.

17. The method of claim 14, wherein generating one or more virtual objects includes generating at least one of:
a set of virtual vehicles to include in the animation based on traffic conditions at the geographic area;
a set of virtual people to include in the animation based on a crowd size at the geographic area;
sunlight, clouds, rain, ice, or snow to include in the animation based on weather conditions at the geographic area; or
lighting conditions to include in the animation based on ambient lighting at the geographic area.

18. The method of claim 14, wherein generating an animation of the geographic area further includes:
generating, by the one or more processors, audio of current ambient sounds within the geographic area based on the condition data.

19. The method of claim 14, further comprising:
receiving, by the one or more processors from the client device, a request for the animation of the geographic area; and
providing, by the one or more processors, the animation to the client device in response to the request.

20. The method of claim 14, further comprising:
determining, by the one or more processors, a direction in which a user of the client device is traveling;
obtaining, by the one or more processors, condition data for a particular orientation for viewing the geographic area based on the determined direction of travel; and
generating, by the one or more processors, the animation of the geographic area based on the condition data.
